(19) United States
(12) Patent Application Publication
(10) Pub. No.: US 2019/0032837 A1
(43) Pub. Date: Jan. 31, 2019

(54) FLUID HOSE STABILIZING DEVICE, FLUID HOSE AND CLEANING APPARATUS

(71) Applicant: Alfred Kärcher SE & Co. KG, Winnenden (DE)

(72) Inventors: Heinz-Peter Ulrichskoetter, Remshalden (DE); Steffen Schlichenmaier, Weissach im Tal (DE)

(21) Appl. No.: 16/146,329

(22) Filed: Sep. 28, 2018

Related U.S. Application Data
(63) Continuation of application No. PCT/EP2016/057121, filed on Mar. 31, 2016.

(51) Int. Cl. F16L 57/02; A47L 9/24; A47L 9/00; A47L 5/36; A47L 5/38

(52) U.S. Cl. CPC F16L 57/02; A47L 9/248; A47L 5/38; A47L 5/36; A47L 9/0036

(57) ABSTRACT

The present invention relates to a fluid hose stabilizing device for stabilizing a fluid hose of a cleaning apparatus, wherein the fluid hose stabilizing device includes at least one device section having a first and a second end, in that the device section has a modulus of elasticity, in that the modulus of elasticity changes starting from the first end in a direction towards the second end of the device section, in that the fluid hose stabilizing device comprises at least one elongated, rod-shaped and elastically bendable reinforcing element and wherein the at least one reinforcing element forms the device section at least in part or sections. Furthermore, improved fluid hoses and cleaning apparatuses are provided.

### CROSS-REFERENCE TO RELATED APPLICATIONS

This application is a continuation of international application number PCT/EP2016/057121 filed on Mar. 31, 2016, which is incorporated herein by reference in its entirety and for all purposes.

### FIELD OF THE INVENTION

The present invention relates to stabilizing devices generally, and more specifically to a fluid hose stabilizing device for stabilizing a fluid hose of a cleaning apparatus.

The present invention further relates to fluid hoses generally, and more specifically to a fluid hose for a cleaning apparatus.

Furthermore, the present invention relates to a cleaning apparatus.

### BACKGROUND OF THE INVENTION

Cleaning apparatuses of the kind described at the outset are known in many ways, for example as suction apparatuses or high-pressure cleaning apparatuses. Such apparatuses are in particular provided as self-service cleaning apparatuses in, for example, filling stations or self-service cleaning facilities. In a stationary, i.e. non-movable, cleaning apparatus, the fluid hose must be a certain length in order that, for example when cleaning a vehicle, a person can reach any desired location on the vehicle with a free end of the fluid hose; therefore, fluid hose stabilizing devices of the kind mentioned at the outset are used for providing a guide for the fluid hose. These comprise for example booms, piping systems surrounding the fluid hose or block and tackle arrangements with springs or with weights, which in particular are fixed to the cleaning apparatus or a boom on the one hand and to the fluid hose on the other. Also known, as an alternative in lieu of such fluid hose stabilizing devices, are winding devices for winding up the fluid hose so that it is only paid out to the length necessitated by its particular use.

The known solutions are in part very complex and therefore associated with a high installation effort and correspondingly high cost.

### SUMMARY OF THE INVENTION

In a first aspect of the invention, a fluid hose stabilizing device for stabilizing a fluid hose of a cleaning apparatus is provided. The fluid hose stabilizing device comprises at least one device section having a first and a second end. The device section has a modulus of elasticity. The modulus of elasticity changes starting from the first end in a direction towards the second end of the device section. The fluid hose stabilizing device comprises at least one elongated, rod-shaped and elastically bendable reinforcing element and the at least one reinforcing element forms the device section at least in part or sections

In a second aspect of the invention, a fluid hose for a cleaning apparatus comprises a fluid hose stabilizing device for stabilizing the fluid hose. The fluid hose stabilizing device comprises at least one device section having a first and a second end. The device section has a modulus of elasticity. The modulus of elasticity changes starting from the first end in a direction towards the second end of the device section. The fluid hose stabilizing device comprises at least one elongated, rod-shaped and elastically bendable reinforcing element and the at least one reinforcing element forms the device section at least in part or sections.

In a third aspect of the invention, a cleaning apparatus comprises a fluid hose. The fluid hose comprises a fluid hose stabilizing device for stabilizing the fluid hose. The fluid hose stabilizing device comprises at least one device section having a first and a second end. The device section has a modulus of elasticity. The modulus of elasticity changes starting from the first end in a direction towards the second end of the device section. The fluid hose stabilizing device comprises at least one elongated, rod-shaped and elastically bendable reinforcing element and the at least one reinforcing element forms the device section at least in part or sections.

### BRIEF DESCRIPTION OF THE DRAWING FIGURES

The foregoing summary and the following description may be better understood in conjunction with the drawing figures, of which:

FIG. 1 shows a schematic representation of a cleaning apparatus in accordance with the invention, with a fluid hose and a fluid hose stabilizing device in a basic position;

FIG. 2 shows a schematic representation of the arrangement in FIG. 1 in a position in which the fluid hose is deflected;

FIG. 3 shows a schematic side view of an exemplary embodiment of a fluid hose stabilizing device;

FIG. 4 shows a schematic side view of a further exemplary embodiment of a fluid hose stabilizing device;

FIG. 5 shows a schematic sectional view of a fluid hose and a fluid hose stabilizing device connected thereto;

FIG. 6 shows a schematic side view, partly in section, of a further exemplary embodiment of a fluid hose with a fluid hose stabilizing device coupled thereto;

FIG. 7 shows a schematic side view, partly in section, of a further exemplary embodiment of a fluid hose with a fluid hose stabilizing device coupled thereto;

FIG. 8 shows a schematic side view, partly in section, of a further exemplary embodiment of a fluid hose with a fluid hose stabilizing device coupled thereto;

FIG. 9 shows a schematic side view of a further exemplary embodiment of a fluid hose stabilizing device;

FIG. 10 shows a schematic side view of a further exemplary embodiment of a fluid hose stabilizing device;

FIG. 11 shows a schematic sectional view of a fluid hose with a fluid hose stabilizing device coupled thereto;

FIG. 12 shows a schematic side view, partly in section, of a further exemplary embodiment of a fluid hose with a fluid hose stabilizing device coupled thereto;

FIG. 13 shows a schematic side view of a further exemplary embodiment of a fluid hose with a fluid hose stabilizing device coupled thereto;

FIG. 14 shows a schematic side view, partly in section, of a further exemplary embodiment of a fluid hose with a fluid hose stabilizing device coupled thereto;

FIG. 15 shows a schematic sectional view of a fluid hose with a plurality of reinforcing elements in surrounding relationship therewith;

FIG. 16 shows a schematic sectional view of a fluid hose with a plurality of reinforcing elements coupled thereto;

FIG. 17 shows a schematic sectional view of a further exemplary embodiment of a fluid hose with a plurality of reinforcing elements coupled thereto;

FIG. 18 shows a schematic side view of a further exemplary embodiment of a fluid hose stabilizing device comprising a plurality of reinforcing elements;

FIG. 19 shows a schematic side view of a further exemplary embodiment of a fluid hose stabilizing device comprising a plurality of reinforcing elements;

FIG. 20 shows a schematic side view of a further exemplary embodiment of a fluid hose stabilizing device comprising a plurality of reinforcing elements;

FIG. 21 shows a schematic side view of a further exemplary embodiment of a fluid hose stabilizing device with a plurality of reinforcing elements;

FIG. 22 shows a schematic side view of a further exemplary embodiment of a fluid hose stabilizing device with a plurality of reinforcing elements;

FIG. 23 shows a schematic side view of a further exemplary embodiment of a fluid hose stabilizing device with a plurality of reinforcing elements;

FIG. 24 shows a schematic side view of a further exemplary embodiment of a fluid hose stabilizing device with a plurality of reinforcing elements;

FIG. 25 shows a schematic representation of a dependency of the retraction force, exerted by the fluid hose stabilizing device, on the distance a free end of the fluid hose has from a point of exit of the hose from a housing of the cleaning apparatus; and

FIG. 26 shows a schematic representation of the procedure when measuring the distance dependency of the retraction force shown in FIG. 25.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The present invention relates to a fluid hose stabilizing device for stabilizing a fluid hose of a cleaning apparatus, wherein the fluid hose stabilizing device comprises at least one device section having a first and a second end, in that the device section has a modulus of elasticity, in that the modulus of elasticity changes starting from the first end in a direction towards the second end of the device section, in that the fluid hose stabilizing device comprises at least one elongated, rod-shaped and elastically bendable reinforcing element and wherein the at least one reinforcing element forms the device section at least in part or sections.

Such a fluid hose stabilizing device provides a simple way of stabilizing a fluid hose, in particular over part of its length, in a desired manner. In addition, by the changing modulus of elasticity of the device section, a restoring force acting from the fluid hose stabilizing device in case of a deflection of the fluid hose is non-linearly adjustable. In this way, the handling of the fluid hose can be improved because significant forces for moving and deflecting the fluid hose from a basic position are only necessary if the fluid hose actually requires extreme deflection. In particular, the fluid hose stabilizing device can prevent kinking of the fluid hose along the longitudinal extension of the fluid hose stabilizing device, i.e., for example all the way from its exit from a cleaning apparatus to a free end thereof. Furthermore, the fluid hose stabilizing device can in particular also prevent the fluid hose from touching the ground. Preferably, a length and the modulus of elasticity of the fluid hose stabilizing device are matched to each other and to the fluid hose stabilized thereby such that at no time will the fluid hose touch the ground, independent of a deflection of the fluid hose and the fluid hose stabilizing device from a basic position. Thus, for example, the fluid hose is not to touch the ground even when the fluid hose engages with its free end in a holder provided therefor on the cleaning apparatus. Thus, in particular, the fluid hose stabilizing device keeps the fluid hose at a predetermined height. A rod-shaped reinforcing element can optionally also be hollow, at least in sections thereof, or, for example, continuously throughout, so that the reinforcing element can have formed therein open or closed cavities or a longitudinal channel passing through the reinforcing element.

It is advantageous for the modulus of elasticity to change, at least in sections, continuously and/or in at least one step between the first and the second end. By way of example, the modulus of elasticity can change in one or more steps, i.e. it can remain constant along part of the device section, then change, for example decrease, in one step, then remain constant again and optionally change again in one or also more steps. However, the modulus of elasticity can also decrease continuously or also exponentially. In principle, all variants are conceivable here.

Preferably, the modulus of elasticity of the device section decreases between the first and the second end. By way of example, when the first end of the device section is arranged closer to the cleaning apparatus than is the second end of the device section, a pulling force exerted on a free end of the fluid hose facing away from the cleaning apparatus first only leads to a deformation of the area of the fluid stabilizing device that has the smallest modulus of elasticity, i.e. that is easiest to deform. It is thereby possible for a deformation of the whole fluid hose stabilizing device to be predetermined in the desired manner and, therefore, for the fluid hose to be stabilized and guided or supported in a defined manner.

A particularly simple and cost-effective way of configuring the fluid hose stabilizing device is to produce or form the at least one elongated reinforcing element from a non-reinforced plastics material or a non-fiber-reinforced plastics material or a plastics material reinforced with glass fibers or carbon fibers or from at least one leaf spring. In particular, a plurality of leaf springs of different lengths can be bundled together to form a leaf spring pack and can optionally be connected together at a common end. The at least one leaf spring can be made of a spring steel for example. Optionally, the at least one leaf spring can be provided with an anti-corrosion layer, for example a powder coating or plastic coating.

Advantageously, the fluid hose stabilizing device has a fixing section for fixing or attaching to a cleaning apparatus. In particular, the fixing section provides a simple way of fixing the fluid hose stabilizing device to a cleaning apparatus. By way of example, the fixing section can be adapted to a receptacle of the cleaning apparatus such that the fixing section can be inserted in the receptacle in force-locking connection and/or form-locking connection therewith.

It is advantageous for the fixing section to extend starting from a first end of the fluid hose stabilizing device. This provides a simple way of fixing the fluid hose stabilizing device at its first end or in an area of its first end to a cleaning apparatus or the like. The fluid hose can then optionally be coupled or fixed to the fluid hose stabilizing device along an extension thereof. While provision may be made for fixing the fluid hose along the fixing section, it is not an absolute requirement.

It is advantageous for the fixing section to have a first and a second end and for a modulus of elasticity of the fixing section to be constant or substantially constant along the extension of the fixing section from the first end to the second end thereof. By way of example, such a fixing section may be easily formed from one or more reinforcing elements which have a constant cross-section overall. For such a fixing section, a corresponding receptacle on a cleaning apparatus is also easily formed.

In another preferred embodiment of the invention, provision may be made for the fluid hose stabilizing device to comprise a plurality of elongated, rod-shaped and elastically bendable reinforcing elements. For example, this provides a simple way of changing a modulus of elasticity of the fluid hose stabilizing device by changing a number of the reinforcing elements that are used to form it.

It is advantageous for the plurality of reinforcing elements each to have a different length. In this way, a modulus of elasticity of the fluid hose stabilizing device changes, in particular in steps, by changing a number of the reinforcing elements, used to form the fluid hose stabilizing device, along individual device sections. For example, two identical reinforcing elements have a lower modulus of elasticity than three or more reinforcing elements of the same kind that extend over the same device section.

The fluid hose stabilizing device is produced in a particularly simple way if at least one of the plurality of reinforcing elements has a constant cross-section along its extension. For example, this provides a simple way of forming a fluid hose stabilizing device from identically shaped rods with identical cross-sections, for example a circular, oval or polygonal cross-section, wherein the reinforcing elements differ only in their lengths.

The fluid hose stabilizing device is produced in a simple way if at least one of the plurality of reinforcing elements has a constant modulus of elasticity along its extension. By way of example, the at least one of the plurality of reinforcing elements can be configured in a simple way by forming it with a constant cross-section along its extension.

It can be further advantageous for the at least one reinforcing element or for at least one of the plurality of reinforcing elements to have a decreasing cross-section along its extension. In particular, the cross-section can decrease continuously and/or in at least one step. In particular, just one single reinforcing element can be provided that changes its cross-section in the manner described. By virtue of the decreasing cross-section of at least one of the plurality of reinforcing elements, a modulus of elasticity of the fluid hose stabilizing device can be changed continuously and in steps in sections thereof.

It is advantageous for the at least one reinforcing element or at least one of the plurality of reinforcing elements to have a first end and a second end and for a modulus of elasticity to change starting from the first end in a direction towards the second end. In particular, the modulus of elasticity can change continuously and/or in at least one step. In this way, the modulus of elasticity of the fluid hose stabilizing device can be adjusted as desired.

Preferably, the modulus of elasticity of the at least one reinforcing element or of the at least one of the plurality of reinforcing elements decreases between the first and the second end. Therefore, an elasticity and a deformability of the fluid hose stabilizing device decreases successively towards a free end thereof which is coupled to the fluid hose and when a pulling force occurs, the fluid hose stabilizing device is first deformed there and is then deformed towards the other end thereof only as the pulling force continues to increase, wherein said other end can be fixed to the cleaning apparatus in particular.

Advantageously, the plurality of reinforcing elements are formed separately from one another. This makes them easy to handle and, optionally, in case of damage, individually replaceable. Furthermore, if it becomes necessary to increase the modulus of elasticity, an additional reinforcing element may simply be added thereto for forming the fluid hose stabilizing device.

A particularly simple and stable way of configuring the fluid hose stabilizing device is to connect or couple together the plurality of reinforcing elements in a bundle-like manner for forming the fluid hose stabilizing device. For example, the plurality of reinforcing elements can be coupled together by sheathing or by connecting elements such as clamps or cable ties or the like.

In accordance with another preferred embodiment of the invention, provision may be made for the plurality of reinforcing elements to be arranged such that a first end of the fluid hose stabilizing device is defined by at least one first end of one of the plurality of reinforcing elements. In particular, the first end of the fluid hose stabilizing device can be defined by all first ends of the plurality of reinforcing elements. In this way, the plurality of reinforcing elements are easily fixed to, for example, a cleaning apparatus or the like.

It is advantageous for the plurality of reinforcing elements to be arranged such that a second end of the fluid hose stabilizing device is defined by at least one second end of the plurality of reinforcing elements. In particular, the second end of the fluid hose stabilizing device can be defined by all second ends of the plurality of reinforcing elements. In this latter case, the plurality of reinforcing elements at least partially have a modulus of elasticity that changes along their extension, for example continuously and/or in steps. If a plurality of reinforcing elements of different lengths are arranged, merely a single second end of one of the plurality of reinforcing elements forms the second end of the fluid hose stabilizing device. In the area of said second end, the modulus of elasticity of the fluid hose stabilizing device is then at its lowest.

It is further advantageous for the plurality of reinforcing elements to be arranged one after the other such that their respective individual lengths add up to an overall length. In this way, for example, a fluid hose stabilizing device can be formed with a plurality of sections whose moduli of elasticity are defined by the elastic moduli of the individual reinforcing elements. The modulus of elasticity can then be graded, particularly in the transition area between two reinforcing elements connected to each other in a force-locking and/or form-locking relationship or by substance-to-substance bonding.

In order for an elasticity of the fluid hose stabilizing device to be adjustable as desired in a more individual way, for example depending on the type of hose and the type of cleaning apparatus, it is advantageous for the plurality of reinforcing elements to be made of different materials. In particular, they can be made of materials having different moduli of elasticity. This provides a simple way of adjusting the modulus of elasticity of the whole fluid hose stabilizing device as desired by replacing one or more reinforcing elements with reinforcing elements made of other materials.

It is further advantageous for the fluid hose stabilizing device to comprise a fixing device for fixing the fluid hose stabilizing device to a fluid hose of a cleaning apparatus. The fixing device makes the fluid hose stabilizing device easy to fix to, for example, fluid hoses of cleaning apparatuses already in use.

It is advantageous for the fixing device to comprise at least one fixing element for fixing the fluid hose stabilizing device to a fluid hose of a cleaning apparatus. Of course, a plurality of fixing elements can be provided in order to fix the fluid hose stabilizing device along the extension thereof to a fluid hose in a defined manner, in particular in a manner that still allows for relative movement between the fluid hose and the fluid hose stabilizing device.

A particularly simple and cost-effective way of configuring the fluid hose stabilizing device is to configure the at least one fixing element in the form of a clamp, a cable tie or a sheath tube for receiving the fluid hose and the fluid hose stabilizing device. Of course, all other types of fixing known to the skilled person to connect the fluid hose stabilizing device to the fluid hose are also conceivable.

For use of the fluid hose stabilizing device, in particular with a stationary cleaning apparatus, it is advantageous for the fluid hose stabilizing device and/or the at least one reinforcing element to have a length in a range of approximately 1 m to approximately 3 m. In particular, the length can be in a range of approximately 1.2 m to approximately 2 m. In particular, the length can be a free length, i.e. exclusive of the fixing section described above. A free length of the at least one reinforcing element in this case is then the length along which the reinforcing element is not coupled to, for example, the cleaning apparatus or the like and along which it is freely deformable, in particular stressable in bending.

A particularly cost-effective and compact configuration of the fluid hose stabilizing device is achieved when the at least one reinforcing element has a maximum diameter in a range of approximately 9 mm to approximately 20 mm, in particular in a range of approximately 11 mm to approximately 15 mm, and when the at least one reinforcing element has a minimum diameter in a range of approximately 2 mm to approximately 10 mm, in particular in a range of approximately 3 mm to approximately 7 mm. Preferably, the maximum diameter of the reinforcing element is defined at one end of the reinforcing element and the minimum diameter is defined at the other end of the reinforcing element.

The invention further relates to a fluid hose for a cleaning apparatus, comprising a fluid hose stabilizing device for stabilizing the fluid hose, wherein the fluid hose stabilizing device comprises at least one device section having a first and a second end, in that the device section has a modulus of elasticity, in that the modulus of elasticity changes starting from the first end in a direction towards the second end of the device section, in that the fluid hose stabilizing device comprises at least one elongated, rod-shaped and elastically bendable reinforcing element and wherein the at least one reinforcing element forms the device section at least in part or sections.

In particular, a fluid hose having such a configuration then has the advantages described above in conjunction with preferred embodiments of fluid hose stabilizing devices. Furthermore, the fluid hose and the fluid hose stabilizing device can be supplied ready-made as a unit for connection to a cleaning apparatus.

Preferably, the fluid hose is configured in the form of a suction hose for a cleaning apparatus in the form of a suction apparatus. The fluid hose can thus be utilized for vacuum-cleaning, for example for vacuuming-out soiled motor vehicles.

Furthermore, it is advantageous for the fluid hose to be configured in the form of a high-pressure hose for a cleaning apparatus in the form of a high-pressure cleaning apparatus. Such a fluid hose can be used, for example, to convey water or other cleaning liquids under high pressure to an object that is to be cleaned.

According to another preferred embodiment of the invention, provision may be made for the fluid hose to comprise a fixing device for fixing the fluid hose stabilizing device along at least part of an overall length of the fluid hose. For example, this provides a way of coupling or connecting the fluid hose to the fluid hose stabilizing device at at least one point or in one area or even also along an overall longitudinal extension of the fluid hose stabilizing device.

The fluid hose is configured in a particularly simple way when the fixing device comprises at least one fixing element for fixing the fluid hose stabilizing device along at least part of an overall length of the fluid hose. A plurality of fixing elements can be provided in order to fix the fluid hose to the fluid hose stabilizing device, in particular along an overall longitudinal extension thereof.

It is advantageous for the at least one fixing element on the fluid hose to be arranged or configured such that the fluid hose stabilizing device is, at least at its free end or in the area of its free end, coupled and guided with the fluid hose or even fixed thereto. In this way, the fluid hose can, in at least an area or section thereof, be connected to the fluid hose stabilizing device in a defined manner. Of course, the at least one fixing element can also be configured such that it receives the fluid hose stabilizing device completely or at least in sections.

A simple and cost-effective way of configuring the fluid hose is to configure the at least one fixing element in the form of a clamp, a cable tie or a sheath tube for receiving the fluid hose and the fluid hose stabilizing device. In particular, the sheath tube can thus surround the fluid hose stabilizing device and the fluid hose together. For example, the sheath tube can be configured in the form of a shrink tube. This can deform, for example, at temperatures above 70° C. It is particularly advantageous for the sheath tube to be formed of a UV-resistant material. Preferably, the material from which the sheath tube is formed is sufficiently flexible even after the reception of the fluid hose and the fluid hose stabilizing device and in particular, where the tube is configured as a shrink tube, after being shrunk. Furthermore, the material from which the sheath tube is formed is preferably non-embrittling.

It is advantageous for the at least one fixing element to be connected to the fluid hose in a force-locking connection or in a form-locking connection or with a substance-to-substance bond or to be formed in one piece with the fluid hose. In this way, depending on the particular configuration, the fixing element can be connected to the fluid hose in a simple manner or enables simple connection of the fluid hose and the fluid hose stabilizing device, in particular when the fixing element itself no longer needs to be connected to the fluid hose, such as when it is formed in one piece therewith, for example.

A simple and cost-effective configuration of the fluid hose is achieved when the at least one fixing element is integrally formed on the fluid hose. By way of example, it can be integrally molded on the fluid hose by injection molding. In such a case, the fluid hose stabilizing device can then simply be pushed through the at least one fixing element in order to couple together the fluid hose and the fluid hose stabilizing device.

A particularly simple way of coupling or connecting together the fluid hose and the fluid hose stabilizing device is to configure the at least one fixing element in the form of a receptacle for the fluid hose stabilizing device. By way of example, the receptacle can be configured in the form of a lug or loop through which the fluid hose stabilizing device is allowed to pass. In this way, the fluid hose stabilizing device can be inserted through one or more receptacles similar to, for example, inserting a belt through the belt loops on a pair of trousers.

The fluid hose stabilizing device can be arranged in a particularly well-protected manner if the receptacle is configured for receiving the whole fluid hose stabilizing device. This also comes with aesthetic advantages in that in this way the fluid hose stabilizing device itself is not visible to a user. In particular, the receptacle can be integrally formed on the fluid hose, for example in the form of a laterally integrally formed pocket whose cross-section is configured in a manner essentially corresponding to a cross-section of the fluid hose stabilizing device.

The receptacle is preferably configured for receiving the at least one elongated rod-shaped reinforcing element. In particular, where a plurality of reinforcing elements are provided, a plurality of receptacles can also be provided, for example on an outer side of the fluid hose and in surrounding relationship therewith.

In order to allow as little relative movement as possible between the fluid hose and the fluid hose stabilizing device, it is advantageous for the receptacle to be configured for receiving a single, elongated, rod-shaped reinforcing element. In particular, this provides a way of minimizing the risk of the fluid hose rubbing through because of relative movements of the fluid hose and the fluid hose stabilizing device relative to each other.

Advantageously, the fluid hose comprises a plurality of fixing elements. In particular, two, three, four, five, six, seven, eight or more fixing elements can be provided. In particular, these may depend on the number of reinforcing elements from which the fluid hose stabilizing device is formed or on a length of the fluid hose stabilizing device.

In order to achieve stabilization of the fluid hose by the fluid hose stabilizing device on all sides in particular, it is advantageous for the plurality of reinforcing elements to be fixed to the fluid hose in surrounding relationship therewith. For example, the reinforcing elements can be fixed to the fluid hose with longitudinal axes thereof in parallel to a longitudinal axis of the fluid hose.

The fluid hose can be configured in a particularly cost-effective manner and with a desired flexibility if it is made of a plastics material. In particular, it can be produced by extrusion or injection molding. By way of example, it can be configured in the form of a corrugated hose which is stabilized by a spiral-shaped stabilizing wire or by a multiplicity of wire rings that are arranged in spaced-apart relationship to each other. In particular, it is thereby possible to prevent the hose from collapsing when used with a suction apparatus.

In order to be able to clean devices, in particular vehicles, easily with the fluid hose, it is advantageous for the fluid hose to be elastically deformable. It can then easily be introduced into the interior of a vehicle, for example.

When using stationary cleaning apparatuses in particular, in order to be able to clean objects, in particular vehicles, as readily as possible, it is advantageous for the fluid hose to have a length in a range of approximately 4 m to approximately 12 m. In particular, the length is in a range of approximately 4.5 m to approximately 6.5 m or in a range of approximately 8 m to approximately 12 m. Preferably, it is approximately 5.5 m or approximately 10 m. Fluid hoses having a length in a range of approximately 4.5 m to approximately 6.5 m are preferably useful as suction hoses for suction apparatuses. By way of example, such a fluid hose allows for a vehicle to be vacuumed out without needing to move the vehicle several times relative to a stationary cleaning station. Fluid hoses having a length in a range of approximately 8 m to approximately 12 m, in particular a length of approximately 10 m, are preferably useful as high-pressure hoses for high-pressure cleaning apparatuses.

The invention further relates to a cleaning apparatus comprising a fluid hose, said fluid hose comprising a fluid hose stabilizing device for stabilizing the fluid hose, wherein the fluid hose stabilizing device comprises at least one device section having a first and a second end, in that the device section has a modulus of elasticity, in that the modulus of elasticity changes starting from the first end in a direction towards the second end of the device section, in that the fluid hose stabilizing device comprises at least one elongated, rod-shaped and elastically bendable reinforcing element and wherein the at least one reinforcing element forms the device section at least in part or sections.

A cleaning apparatus having such a configuration then has the advantages described above in particular in conjunction with preferred embodiments of fluid hoses and fluid hose stabilizing devices.

It is advantageous for the cleaning apparatus to be configured in the form of a suction apparatus or in the form of a high-pressure cleaning apparatus. With such a cleaning apparatus, dirt can be sucked off or removed by applying a high-pressure cleaning jet.

Advantageously, the cleaning apparatus is configured in the form of a stationary cleaning apparatus. It can then be employed as a suction apparatus or as a high-pressure cleaning apparatus in, for example, self-service cleaning facilities.

Furthermore, it can be advantageous for the cleaning apparatus to be configured in the form of a mobile cleaning apparatus. In particular, it can be configured in the form of a portable or travelling cleaning apparatus. By way of example, such a cleaning apparatus can be readily brought to a different location. Such a cleaning apparatus can advantageously be used for mobile cleaning facilities in particular.

According to a further preferred embodiment of the invention, provision may be made for the cleaning apparatus to have a receptacle or holder for the fluid hose stabilizing device and/or for the fluid hose. By way of example, separate receptacles or holders can be provided for the fluid hose on the one hand and for the fluid hose stabilizing device on the other. This provides a simple way of replacing the fluid hose stabilizing device and the fluid hose without having to replace both parts. It may, however, also be provided to have only a single receptacle or holder on the cleaning apparatus in order to connect the fluid hose, together with a fluid hose stabilizing device held thereon, to the cleaning apparatus. This is particularly advantageous if the whole fluid hose stabilizing device is arranged in a receptacle on the fluid hose.

It is advantageous for the cleaning apparatus to have a housing and for the receptacle or the holder for the fluid hose stabilizing device and/or for the fluid hose to be arranged or formed on or in the housing. This makes for a particularly compact configuration of the cleaning apparatus. In addition, free ends of the fluid hose stabilizing device and of the fluid hose can be coupled to the cleaning apparatus inside the housing in a protected manner.

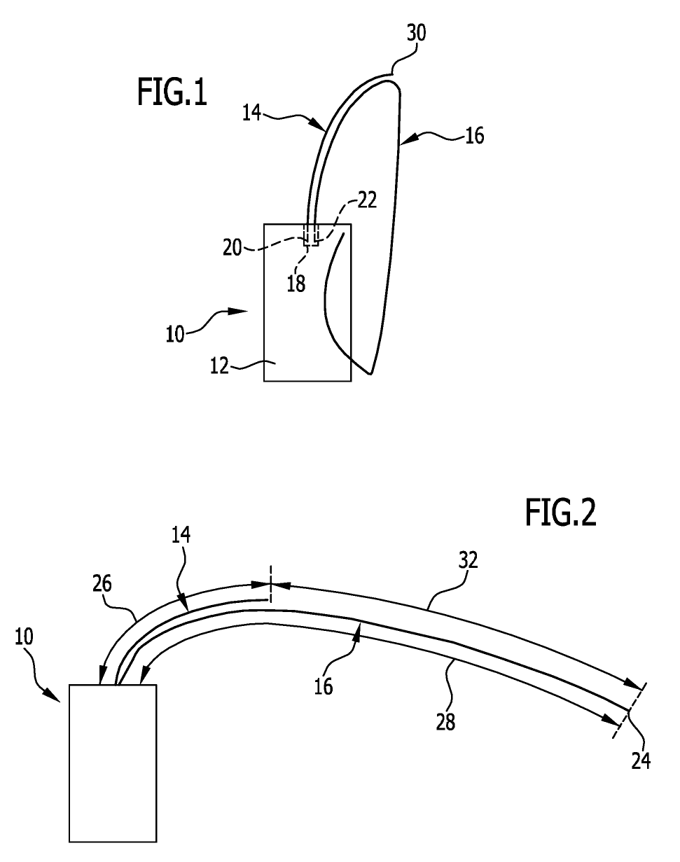

FIGS. 1 and 2 illustrate an example of a cleaning apparatus, designated generally by the reference numeral 10. In particular, the cleaning apparatus 10 can be configured in the form of a suction apparatus or also in the form of a high-pressure cleaning apparatus. It comprises a housing 12, a fluid hose stabilizing device 14 and a fluid hose 16.

Arranged at the housing 12 is a receptacle 18 into which a first end 20 of the fluid hose stabilizing device 14 and a first end 22 of the fluid hose 16 are inserted.

In particular, the fluid hose 16 can be configured as a suction hose if the cleaning apparatus 10 is configured in the form of a suction apparatus or it can be configured in the form of a high-pressure hose if the cleaning apparatus 10 is configured in the form of a high-pressure cleaning apparatus.

In particular, a second end 24 of the fluid hose 16 can be equipped with a suction nozzle if the fluid hose 16 is configured in the form of a suction hose or with a high-pressure gun if the fluid hose 16 is configured in the form of a high-pressure hose.

The length of the fluid hose stabilizing device 14 is of shorter configuration than that of the fluid hose 16; in particular, a free length 26 of the fluid hose stabilizing device 14 is less than one half, in particular less than one third, of a free length 28 of the fluid hose 16. The free lengths 26 and 28 are each to be taken to mean the dimensions the fluid hose stabilizing device 14 and the fluid hose 16 have outside the housing 12.

FIG. 1 shows the cleaning apparatus with the fluid hose 16 in a basic position in which the fluid hose 16 is not deflected.

FIG. 2 shows the cleaning apparatus 10 in a position in which the fluid hose 16 is nearly maximally deflected. The fluid hose stabilizing device 14, which is of elastically bendable configuration, co-deforms therewith in a predetermined manner. In particular, deformation depends on a modulus of elasticity of the fluid hose stabilizing device 14 along the free length thereof. A free, second end 30 of the fluid hose stabilizing device 14 is pulled away from the housing 12, in particular because of it being connected or coupled to the fluid hose 16.

A connection between the fluid hose 16 and the fluid hose stabilizing device 14 is omitted from FIGS. 1 and 2 for clarity. Possible forms of connection between the fluid hose 16 and the fluid hose stabilizing device 14 will be described in detail hereinbelow.

The free length 26 is preferably in a range of approximately 1 m to approximately 2 m. It is in a range of approximately 1.3 m to approximately 1.6 m in particular. The free length 26 may be 1.4 m, for example.

The free length 28 is preferably in a range of approximately 4.5 m to approximately 6.5 m. It is preferably in a range of approximately 5 m to approximately 6 m. The free length 28 may be approximately 5.5 m in particular.

In particular, selecting the free lengths 26 and 28 to be in the indicated ranges enables a motor vehicle to be placed next to the cleaning apparatus 10 and the fluid hose 16 to be maneuvered with the second end 24 thereof to nearly any desired location on the vehicle.

When a pulling force exerted on the second end 24 is removed again, the deflected fluid hose stabilizing device 14 is relieved and automatically returns to the basic position illustrated in FIG. 1. The fluid hose 16, in turn, then again hangs down from the second end 30 of the fluid hose stabilizing device 14 over a residual length 32 which corresponds to a difference between the free lengths 28 and 26.

By way of the fluid hose stabilizing device 14, the fluid hose 16 can be held to the cleaning apparatus 10 in as compact a manner as possible when the fluid hose 16 is not needed. Furthermore, the fluid hose stabilizing device 14 allows the fluid hose 16 to be automatically restored to as compact a basic position as possible after use.

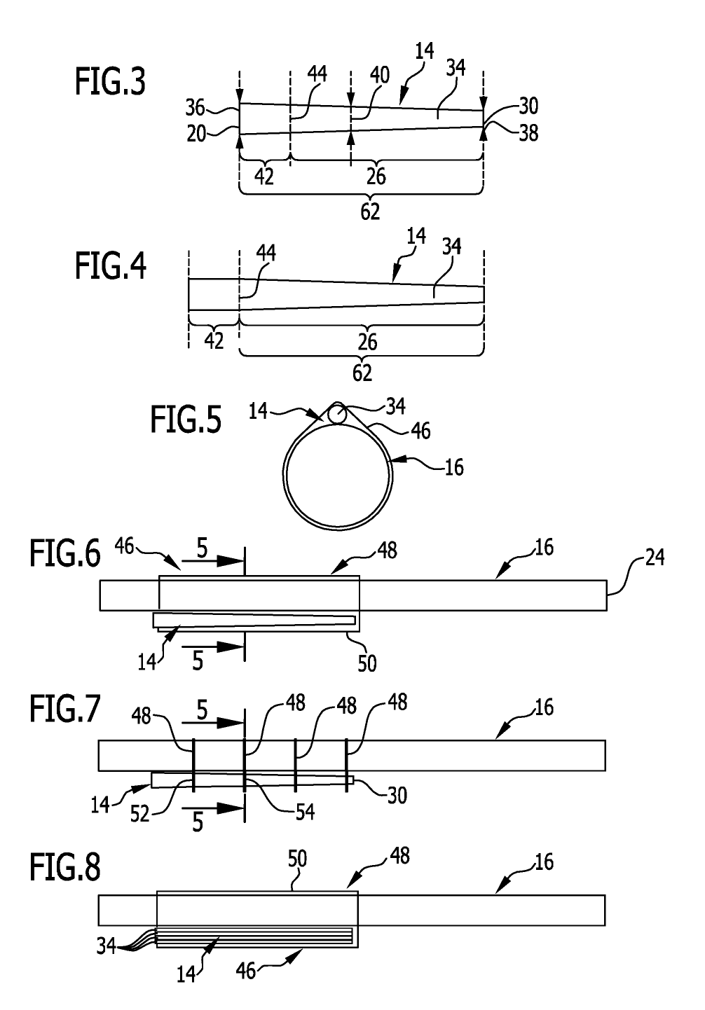

FIG. 3 shows, in a side view, an exemplary embodiment of a fluid hose stabilizing device 14. This comprises a single, elongated, rod-shaped and elastically bendable reinforcing element 34 which has a conical shape overall. A maximum diameter 36 of the reinforcing element 34 is defined by the first end 20; a minimum diameter 38 is defined by the second end 30. A diameter 40 of the reinforcing element 34 decreases continuously between the ends 20 and 30.

Starting from the first end 20, a fixing section 42 extends in a direction towards the second end 30. A length of the fixing section 42 corresponds approximately to a depth of the receptacle 18. A first end of the fixing section 42 is defined by the first end 20; a second end 44 is spaced apart from the second end 30 by the free length 26.

By virtue of the diameter 40 decreasing from the first end 20 towards the second end 30, the reinforcing element 34, and hence also the fluid hose stabilizing device 14, has a device section 62 that has a decreasing modulus of elasticity from the first end 20 in a direction towards the second end 30. As a result, when a pulling force is exerted on the second end 24 of the fluid hose 16, the fluid hose stabilizing device 14 is first deformed from the second end 30 because the modulus of elasticity of the fluid hose stabilizing device 14 increases starting from the second end 30 in a direction towards the first end 20. Therefore, when a pulling force is exerted on the second end 24, the fluid hose stabilizing device 14 does not deform uniformly but deforms particularly heavily starting from the second end 30 and less and less heavily in a direction towards the first end 20.

Virtually no deformation occurs in the area of the fixing section 42 because the latter is held to the cleaning apparatus 10 in a substantially non-deformable manner. Deformation of the fluid hose stabilizing device 14 then only occurs in the area of the free length 26 thereof and in the manner as described.

FIG. 4 schematically shows another exemplary embodiment of a fluid hose stabilizing device 14 as viewed from the side. It differs from the fluid hose stabilizing device 14 illustrated in FIG. 3 only in that the reinforcing element 34 has a fixing section 42 of constant diameter. Thus, the modulus of elasticity of the fluid hose stabilizing device 14 increases starting from the end 30 towards the end 44 in the area of the device section 62, which extends starting from the end 30 over the length 26.

In the exemplary embodiment illustrated in FIG. 3, the diameter of the fixing section 42 decreases continuously starting from the first end 20.

FIG. 6 schematically shows a fluid hose 16 which is stabilized by a fluid hose stabilizing device 14. The latter is connected to the fluid hose by way of a fixing device generally designated by the reference numeral 46. This comprises a fixing element 48 in the form of a sheath tube 50.

As shown in the schematic cross-sectional view in FIG. 5, the sheath tube 50 surrounds both the fluid hose 16 and the fluid hose stabilizing device 14 in contact thereagainst, the latter comprising a single reinforcing element 34. The sheath tube 50 has a length which corresponds to approximately the free length 26. The sheath tube 50 can in particular be configured in the form of a shrink tube which, in a basic state, is slid over the fluid hose 16 and the fluid hose stabilizing device 14 and then shrunk by heating.

FIG. 7 shows an alternative variant of the connection of the fluid hose 16 to the fluid hose stabilizing device 14. In lieu of the sheath tube 50, four fixing elements 48 in the form of clamps 52 or cable ties 54 are illustrated as an example. In particular, these connect the fluid hose stabilizing device 14 and the fluid hose 16 in the area of the second end 30 and at regular intervals in a direction towards the first end 20.

In the exemplary embodiment shown in FIG. 8, the fluid hose stabilizing device 14 is formed by a plurality of reinforcing elements 34. These are connected, in bundle-like contacting relationship with each other, to the fluid hose 16 by a sheath tube 50. In particular, the reinforcing elements 34 can be configured in a form as has been described in detail in connection with FIGS. 3 and 4.

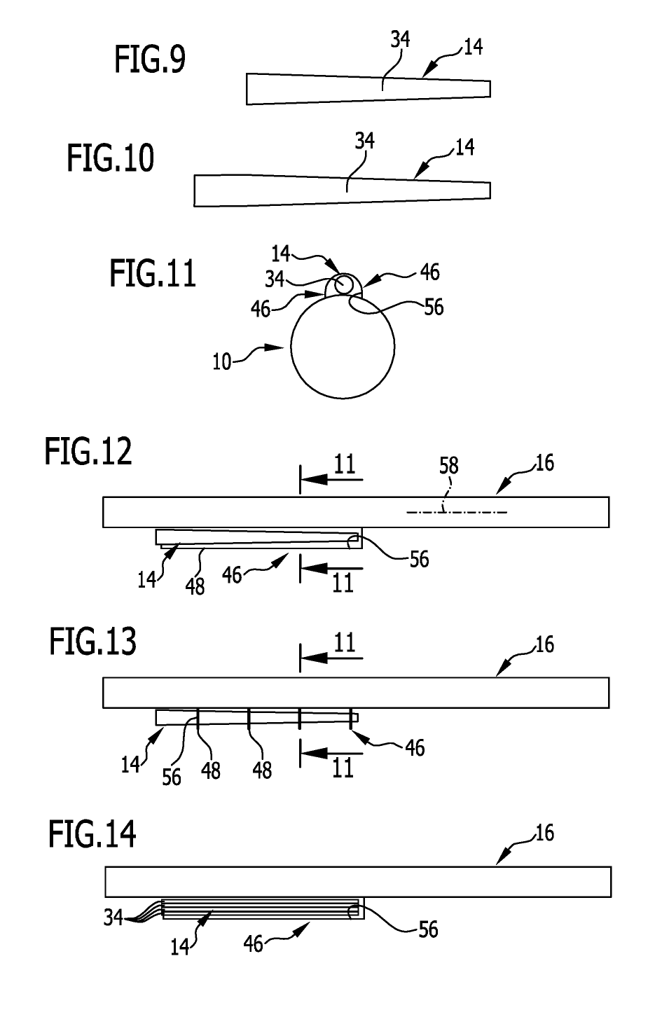

FIG. 9 shows once again a fluid hose stabilizing device 14 as has already been described in detail in connection with FIG. 3.

FIG. 10 shows once again a fluid hose stabilizing device as has already been described in detail in connection with FIG. 4.

FIG. 12 now shows an exemplary embodiment of a fluid hose 16 which has a fixing device 46 laterally integrally formed therewith, namely in the form of a fixing element 48 which is configured as a lateral receptacle 56 into which the fluid hose stabilizing device 14 can be inserted parallel to a longitudinal axis 58 of the non-deformed fluid hose 16. To this end, the receptacle 56 is open in a direction towards the first end 22. An opposite end of the receptacle 56 is optionally closed.

By way of example, FIG. 11 shows a section taken along line 11-11 in FIG. 12. As is clearly shown here, the reinforcing element 34 is located outside of the fluid hose 16 but inside of the receptacle 56.

FIG. 13 shows, as an example, a configuration of the fixing device 46 that comprises four fixing elements 48 integrally formed on or configured in one piece with the fluid hose 16, said fixing elements 48 being configured in the form of lugs or eyelets and each defining a through-opening in the form of a receptacle 56. A sectional view taken along line 11-11 in FIG. 13 in the area of one of the fixing elements 48 corresponds to the sectional view shown schematically in FIG. 11.

FIG. 14 in turn schematically represents a fluid hose stabilizing device 14 which comprises a plurality of reinforcing elements 34. These are inserted into the receptacle 56 which is defined by the fixing device 46.

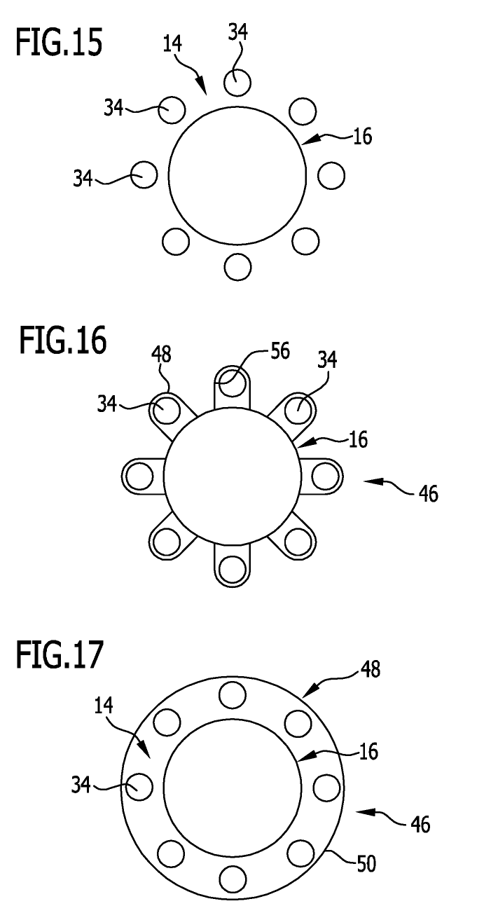

FIG. 15 schematically shows another exemplary embodiment of a fluid hose 16 stabilized with a fluid hose stabilizing device 14 which comprises a plurality of reinforcing elements 34 that are uniformly distributed over a circumference of the fluid hose 16 and are arranged in parallel alignment therewith. Eight reinforcing elements 34 are shown in FIG. 15 as an example. These can in particular be configured as depicted in FIGS. 3 and 4 and described above.

FIG. 16 shows a first variant of a fixing device 46 for connecting the arrangement of the fluid hose stabilizing device 14 shown in FIG. 15 to the fluid hose 16. The fixing device 46 comprises, for each reinforcing element 34, a fixing element 48 in the form of a receptacle 56 as has been described in conjunction with FIGS. 12 and 14.

Alternatively, in lieu of such an elongated receptacle 56, a plurality of fixing elements in the form of lugs or eyelets as depicted in FIG. 13 and described above can be used.

FIG. 17 shows, as an example, a further variant for connecting the fluid hose stabilizing device 14 shown in FIG. 14 to the fluid hose 16. Here, the fixing device 46 comprises a single fixing element in the form of a sheath tube 50. This surrounds the fluid hose 16 and the reinforcing elements 34 surrounding same.

In lieu of the sheath tube 50, a plurality of fixing elements 48 may be provided, namely in a manner as has been described in connection with FIG. 7. The fixing elements 48 can connect the individual reinforcing elements 34 to the fluid hose 16 in the form of a cable tie or a clamp in particular.

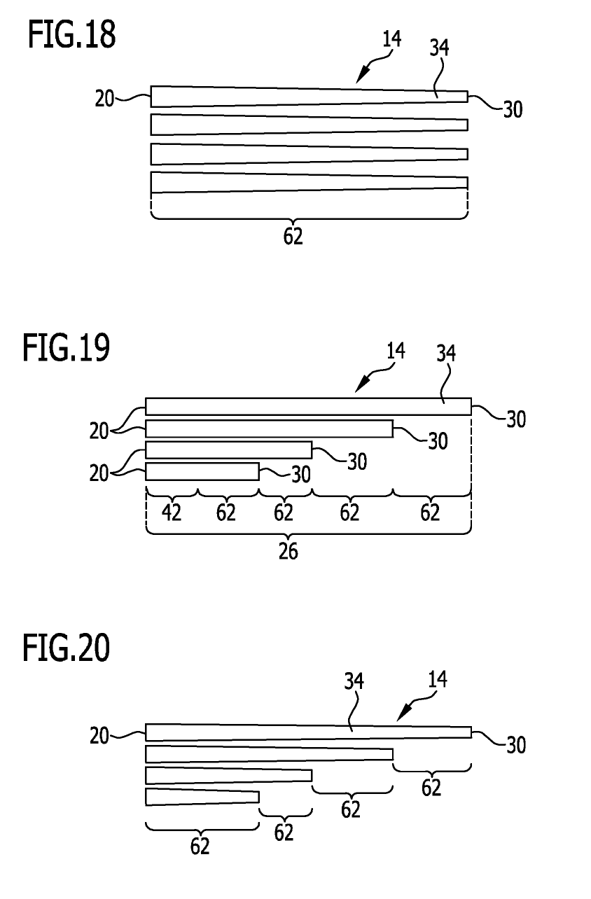

FIG. 18 shows as an example a fluid hose stabilizing device 14 which is formed by a plurality of reinforcing elements 34, four being shown by way of example. Here, any other number of reinforcing elements 34 may be provided. The same applies analogously to the exemplary embodiments of the fluid hose stabilizing devices 14 shown in FIGS. 8 and 14 to 17 and 19 to 24.

In FIG. 18, the reinforcing elements 34 are configured in the form of reinforcing elements as described in detail in connection with FIG. 3. If these are coupled, for example also as described in conjunction with FIGS. 15 to 17, a modulus of elasticity of the fluid hose stabilizing device 14 is obtained which decreases overall from the ends 20 in a direction towards the ends 30.

FIG. 19 schematically represents a further variant of a fluid hose stabilizing device 14. This comprises four reinforcing elements 34 whose ends 20 define a common end of the fluid hose stabilizing device 14. But the reinforcing elements 34 are of different lengths so that in the area of the free length 26 of the fluid hose stabilizing device 14, the modulus of elasticity thereof decreases in three steps so that a total of four different areas, namely four device sections 62 of the fluid hose stabilizing device 14, are formed with different moduli of elasticity. These sections are in each case the sections of the reinforcing elements 34 that extend beyond a second end 30 of the next-shorter reinforcing element 34. The individual reinforcing elements 34 are configured in the form of flexible rods having identical cross-sections.

FIG. 20 shows a modified variant of the arrangement in FIG. 19. Here, however, the reinforcing elements 34 are configured in the form of reinforcing elements as are depicted in FIG. 3 and described above. The result is a superimposed change of the modulus of elasticity of the fluid hose stabilizing device 14 such that it decreases both continuously and in steps, i.e. a combination of the configurations of the fluid hose stabilizing devices 14 as depicted in FIGS. 18 and 19 and described above.

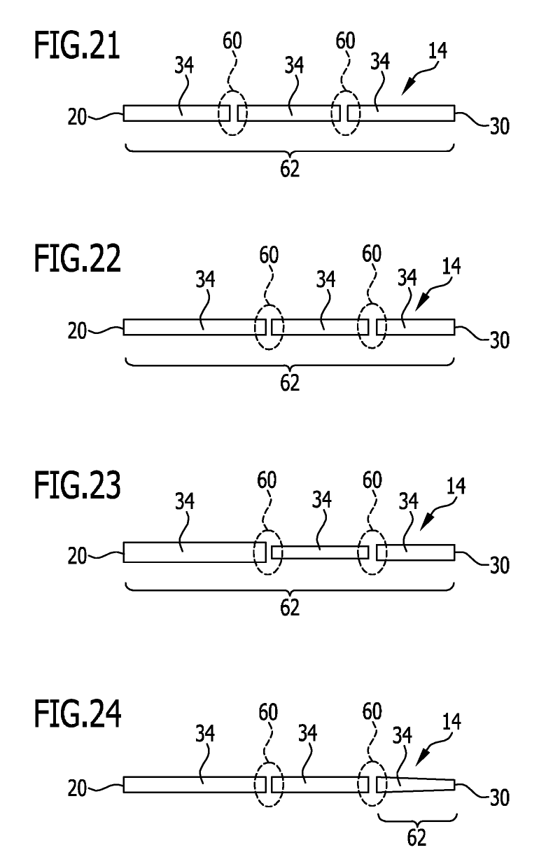

FIGS. 21 to 24 schematically represent further exemplary embodiments of fluid hose stabilizing devices 14, each comprising a plurality of reinforcing elements 34. Shown in FIGS. 21 to 24 are three reinforcing elements 34 as an example.

As shown in FIG. 21, and as also shown in FIGS. 22 to 24, the three reinforcing elements 34 are arranged one behind the other and thus together form a rod. They are connected together via coupling elements 60, shown schematically. The coupling elements 60 can be of elastic configuration and can have different elasticities so that, again, different moduli of elasticity are predetermined for the whole fluid hose stabilizing devices 14 between the ends 20 and 30 thereof.

In the exemplary embodiment of the fluid hose stabilizing device 14 as illustrated in FIG. 21, all three reinforcing elements 34 are of equal length and identical diameter. However, these reinforcing elements 34 can optionally be made of different materials, each with different moduli of elasticity. In this way, again, a fluid hose stabilizing device 14 is obtained having a device section 62 which is defined by the overall arrangement of the three reinforcing elements 34 and has a modulus of elasticity that changes in two steps.

The fluid hose stabilizing device 14 as shown in FIG. 22 as an example has reinforcing elements 34 of differing lengths.

In contrast, the fluid hose stabilizing device 14 as schematically shown in FIG. 23 is configured of three reinforcing elements 34 which have lengths identical to those of the reinforcing elements in FIG. 22 but different diameters and therefore different moduli of elasticity.

By way of example, FIG. 24 illustrates the fluid hose stabilization device 14 as having three reinforcing elements 34 which are of lengths identical to those of the reinforcing elements 34 in FIGS. 22 and 23, but one of the three reinforcing elements 34 is configured in the form of a reinforcing element 34 as is shown in FIG. 3. Therefore, the modulus of elasticity of the overall arrangement of the fluid hose stabilizing device 14 decreases twice in steps from the end 20 towards the end 30 and additionally decreases continuously along the third reinforcing element 34 which defines a device section 62.

The fluid hose stabilizing devices 14 shown in FIGS. 21 to 24 may replace any of the reinforcing elements 34 as are depicted in FIGS. 3 to 20 and described above.

Of course, other combinations, not shown, of the arrangements of reinforcing elements 34 as depicted in the figures and described above for forming fluid hose stabilizing devices 14 for stabilizing fluid hoses 16 are also possible.

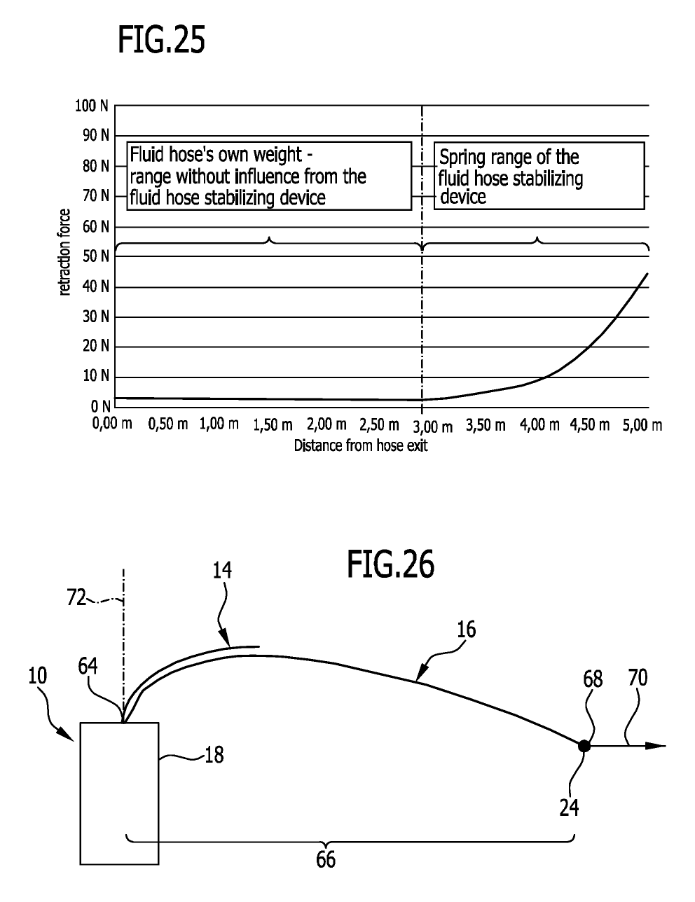

FIG. 25 schematically shows how the retraction force of the fluid hose stabilizing device 14 depends on a distance of the end 24 from a point of exit 64 of the fluid hose stabilizing device 14 from the housing 18. The fluid hose 16 here has an overall length of 5.5 m.

The course of force depending on the distance 66 is shown in FIG. 25 and shows a retraction force that is substantially constant until a deflection at a distance of approximately 3 m. Thereafter, the retraction force increases continuously but non-linearly.

The forces plotted in FIG. 25 were determined by a force sensor 68. The measured retraction force counteracts the deflection force 70. The latter is directed transversely to an exit longitudinal axis 72 of the receptacle 18.

Thus, to make for an arrangement of a fluid hose 16 and a fluid hose stabilizing device 14 that is easily controlled in practice, the retraction force is preferably in a range between 1 N and 100 N, preferably in a range between approximately 1 N and 60 N.

The described variants of fluid hoses are preferably formed from materials that are suitable for use with the media to be flowed therethrough. Acid and base resistant plastics materials in particular can be chosen for forming the liquid hoses 16.

The reinforcing elements 34 are preferably made of a plastics material that is reinforced by glass fibers or carbon fibers.

As described, the configuration of the fluid hose stabilizing device 14 in its simplest form is obtained by use of a single reinforcing element 34 such as is shown in FIG. 3 or 4 for example.

### REFERENCE SYMBOL LIST

10 cleaning apparatus
12 housing
14 fluid hose stabilizing device
16 fluid hose
18 receptacle
20 first end
22 first end
24 second end
26 free length
28 free length
30 second end
32 residual length
34 reinforcing element
36 maximum diameter
38 minimum diameter
40 diameter
42 fixing section
44 second end
46 fixing device
48 fixing element
50 sheath tube
52 clamp
54 cable tie
56 receptacle
58 longitudinal axis
60 coupling element
62 device section
64 point of exit
66 distance
68 force sensor
70 deflection force
72 exit longitudinal axis

What is claimed is:

1. A fluid hose stabilizing device for stabilizing a fluid hose of a cleaning apparatus, wherein the fluid hose stabilizing device comprises at least one device section having a first and a second end, in that the device section has a modulus of elasticity, in that the modulus of elasticity changes starting from the first end in a direction towards the second end of the device section, in that the fluid hose stabilizing device comprises at least one elongated, rod-shaped and elastically bendable reinforcing element and wherein the at least one reinforcing element forms the device section at least in part or sections.

2. The fluid hose stabilizing device in accordance with claim 1, wherein at least one of
a) the modulus of elasticity changes, at least in sections, at least one of continuously and in at least one step between the first and the second end
and
b) the modulus of elasticity of the device section decreases between the first and the second end
and
c) the at least one elongated reinforcing element is produced or formed from a non-reinforced plastics material or a non-fiber-reinforced plastics material or a plastics material reinforced with glass fibers or carbon fibers or from at least one leaf spring.

3. The fluid hose stabilizing device in accordance with claim 1, wherein the fluid hose stabilizing device has a fixing section for fixing or attaching to a cleaning apparatus.

4. The fluid hose stabilizing device in accordance with claim 3, wherein at least one of
a) the fixing section extends starting from a first end of the fluid hose stabilizing device
and
b) the fixing section has a first end and a second end and a modulus of elasticity of the fixing section is constant or substantially constant along the extension of the fixing section from the first end to the second end thereof.

5. The fluid hose stabilizing device in accordance with claim 1, wherein the fluid hose stabilizing device comprises a plurality of elongated, rod-shaped and elastically bendable reinforcing elements.

6. The fluid hose stabilizing device in accordance with claim 5, wherein at least one of
a) the plurality of reinforcing elements each have a different length
and
b) at least one of the plurality of reinforcing elements has a constant cross-section along its extension
and
c) at least one of the plurality of reinforcing elements has a constant modulus of elasticity along its extension
and
d) the plurality of reinforcing elements are formed separately from one another
and
e) the plurality of reinforcing elements are connected or coupled together in a bundle-like manner for forming the fluid hose stabilizing device
and
f) the plurality of reinforcing elements are arranged such that a first end of the fluid hose stabilizing device is defined by at least one first end of one of the plurality of reinforcing elements, in particular by all first ends of the plurality of reinforcing elements
and
g) the plurality of reinforcing elements are arranged such that a second end of the fluid hose stabilizing device is defined by at least one second end of the plurality of reinforcing elements, in particular by all second ends of the plurality of reinforcing elements
and
h) the plurality of reinforcing elements are arranged one after the other such that their respective individual lengths add up to an overall length
and
i) the plurality of reinforcing elements are made of different materials, in particular of materials having different moduli of elasticity.

7. The fluid hose stabilizing device in accordance with claim 1, wherein at least one of
a) the at least one reinforcing element or at least one of the plurality of reinforcing elements has a decreasing cross-section along its extension, in particular a cross-section that decreases at least one of continuously and in at least one step
and
b) the at least one reinforcing element or at least one of the plurality of reinforcing elements has a first end and a second end and wherein a modulus of elasticity changes starting from the first end in a direction towards the second end, in particular continuously and/or in at least one step,
in particular, wherein the modulus of elasticity of the at least one reinforcing element or of the at least one of the plurality of reinforcing elements decreases between the first and the second end.

8. The fluid hose stabilizing device in accordance with claim 1, further comprising a fixing device for fixing the fluid hose stabilizing device to a fluid hose of a cleaning apparatus.

9. The fluid hose stabilizing device in accordance with claim 8, wherein the fixing device comprises at least one fixing element for fixing the fluid hose stabilizing device to a fluid hose of a cleaning apparatus,
in particular, the at least one fixing element is configured in the form of a clamp, a cable tie or a sheath tube for receiving the fluid hose and the fluid hose stabilizing device.

10. The fluid hose stabilizing device in accordance with claim 1, wherein at least one of
a) the at least one reinforcing element has a length, in particular a free length exclusive of the fixing section, in a range of approximately 1 m to approximately 3 m, in particular in a range of approximately 1.2 m to approximately 2 m,
and
b) the at least one reinforcing element has a maximum diameter in a range of approximately 9 mm to approximately 20 mm, in particular in a range of approximately 11 mm to approximately 15 mm, and wherein the at least one reinforcing element has a minimum diameter in a range of approximately 2 mm to approximately 10 mm, in particular, in a range of approximately 3 mm to approximately 7 mm.

11. A fluid hose for a cleaning apparatus, comprising a fluid hose stabilizing device for stabilizing the fluid hose, wherein the fluid hose stabilizing device comprises at least one device section having a first and a second end, in that the device section has a modulus of elasticity, in that the modulus of elasticity changes starting from the first end in a direction towards the second end of the device section, in that the fluid hose stabilizing device comprises at least one elongated, rod-shaped and elastically bendable reinforcing element and wherein the at least one reinforcing element forms the device section at least in part or sections.

12. The fluid hose in accordance with claim 11, wherein the fluid hose is configured in the form of a
a) suction hose for a cleaning apparatus in the form of a suction apparatus
or
b) high-pressure hose for a cleaning apparatus in the form of a high-pressure cleaning apparatus.

13. The fluid hose in accordance with claim 11, wherein the fluid hose comprises a fixing device for fixing the fluid hose stabilizing device along at least part of an overall length of the fluid hose.

14. The fluid hose in accordance with claim 13, wherein the fixing device comprises at least one fixing element for fixing the fluid hose stabilizing device along at least part of an overall length of the fluid hose.

15. The fluid hose in accordance with claim 14, wherein at least one of
a) the at least one fixing element on the fluid hose is arranged or configured such that the fluid hose stabilizing device is, at least at its free end or in the area of its free end, coupled and guided with the fluid hose or fixed thereto
and
b) the at least one fixing element is configured in the form of a clamp, a cable tie or a sheath tube for receiving the fluid hose and the fluid hose stabilizing device
and
c) the at least one fixing element is connected to the fluid hose in a force-locking connection or in a form-locking connection or with a substance-to-substance bond or is formed in one piece with the fluid hose
and
d) the at least one fixing element is integrally formed on the fluid hose, in particular integrally molded thereon by injection molding.

16. The fluid hose in accordance with claim 14, wherein the at least one fixing element is configured in the form of a receptacle for the fluid hose stabilizing device.

17. The fluid hose in accordance with claim 16, wherein at least one of
a) the receptacle is configured for receiving the whole fluid hose stabilizing device
and
b) the receptacle is configured for receiving the at least one elongated rod-shaped reinforcing element,
in particular, wherein the receptacle is configured for receiving a single, elongated, rod-shaped reinforcing element.

18. The fluid hose in accordance with claim 14, further comprising a plurality of fixing elements, in particular two, three, four, five, six, seven, eight or more.

19. The fluid hose in accordance with claim 11, wherein at least one of
a) the plurality of reinforcing elements are fixed to the fluid hose in surrounding relationship therewith
and
b) the fluid hose is made of a plastics material, in particular by extrusion or injection molding
and
c) the fluid hose is of elastically deformable configuration
and
d) it has a length in a range of approximately 4 m to approximately 12 m, in particular in a range of approximately 4.5 m to approximately 6.5 m or in a range of approximately 8 m to approximately 12 m, further particularly a length of approximately 5.5 m or 10 m.

20. A cleaning apparatus comprising a fluid hose, said fluid hose comprising a fluid hose stabilizing device for stabilizing the fluid hose, wherein the fluid hose stabilizing device comprises at least one device section having a first and a second end, in that the device section has a modulus of elasticity, in that the modulus of elasticity changes starting from the first end in a direction towards the second end of the device section, in that the fluid hose stabilizing device comprises at least one elongated, rod-shaped and elastically bendable reinforcing element and wherein the at least one reinforcing element forms the device section at least in part or sections.

21. The cleaning apparatus in accordance with claim 20, wherein at least one of
a) the cleaning apparatus is configured in the form of a suction apparatus or in the form of a high-pressure cleaning apparatus
and
b) the cleaning apparatus is configured in the form of a stationary cleaning apparatus
and
c) the cleaning apparatus is configured in the form of a mobile, in particular portable or travelling, cleaning apparatus
and
d) the cleaning apparatus has a receptacle or holder for the fluid hose stabilizing device and/or for the fluid hose,
in particular, wherein the cleaning apparatus has a housing and wherein the receptacle or the holder for the fluid hose stabilizing device and/or for the fluid hose is arranged or formed on or in the housing.
